(19) United States
(12) Patent Application Publication
(10) Pub. No.: US 2007/0285275 A1
(43) Pub. Date: Dec. 13, 2007

(54) Remote Actuation of a Downhole Tool

(75) Inventors: Daniel Purkis, Aberdeenshire (GB); Iain Morrison MacLaeod, Aberdeenshire (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Petrowell Limited

(21) Appl. No.: 11/667,516

(22) PCT Filed: Sep. 22, 2005
(86) PCT No.: PCT/GB05/03668

§ 371 Date: May 9, 2007

(30) Foreign Application Priority Data
Nov. 12, 2004 (GB) 0425008.0

(51) Int. Cl. G01V 3/00

(52) U.S. Cl. 340/854.6; 343/720

(57) ABSTRACT

A method and apparatus for operating a downhole tool is disclosed. The method involves providing a conduit for the passage of fluid. The conduit includes at least one reader which can read data and is arranged for the passage of fluid. A downhole tool is coupled to the reader and has at least one tag capable of containing data. The tag is moved within the conduit and at least partially through the reader such that the reader can read data from the tag when the tag passes. This enables remote operation of the downhole tool. An antenna is provided for use in a downhole tubular. The antenna comprises a generally cylindrical housing and a coiled conductor located within a portion of the housing and separated therefrom by insulating material. The portion of housing has a greater internal diameter than an external diameter of the coiled conductor.

The present invention relates to remote actuation of a downhole tool. In particular, the invention utilises RFID technology to communicate data and operating instructions to/from static readers coupled to a downhole tool such as a valve or sliding sleeve.

During downhole drilling operations, mud and drilling fluids are circulated within the wellbore by being pumped down through the drill string and returning to the surface via the borehole annulus. Drill cuttings produced during drilling are carried up to the surface through the annulus by the drilling mud. However, in extended reach wells and/or highly deviated or slim diameter wells, the pressure of the drilling mud along the circulation path can drop from that at the surface, which results in a lower cutting lifting performance which in turn can lead to restrictions/obstructions arising in the annulus caused by accumulating cuttings.

In order to alleviate this problem, it is conventional to include one or more downhole circulating subs in the drill string which allow fluid circulation rates to be varied by selectively opening a path from the interior of the drill string to the annulus. Ports in the circulating subs can be opened and closed to enable the flow path of drilling fluids to take a different course, thereby altering the circulation time.

Conventional circulating subs typically comprise a ball seat and, in the event of a restriction in the circulation path at a location in the annulus above that of the circulating sub, a ball, of greater diameter than the seat at its narrowest point, is dropped or pumped through the drill string such that it lands on the ball seat. Once in position, the area above the ball and ball seat becomes sufficiently pressurised to move the ball seat downwards thereby uncovering the ports which enables the drilling fluids to flow through ports in the sidewall of the circulating sub and string into the annulus.

Typically, a series of circulating subs is provided within the drill string at vertically spaced apart points. In view of the method of operation of the ball seats, vertically higher ball seats necessarily have a greater inner diameter than vertically lower ball seats allowing smaller balls destined for the lower seats to bypass higher circulating subs when dropped downhole. Due to the progressively narrower inner diameter required towards the bottom of the casing, a drill string can usually only accommodate a maximum of six such circulating subs.

The aim of the present invention is to provide an improved circulation sub and an improved method of actuating downhole tools which alleviates problems associated with the prior art described hereinbefore and also provides a means of sending instructions and/or data from/to downhole tools.

According to a first aspect of the present invention there is provided apparatus for operating a downhole tool located in a conduit for the passage of fluid therethrough, the apparatus comprising:

at least one reader associated with the conduit, wherein the or each reader is arranged to read data and wherein the at least one reader is also arranged for the passage of fluid therethrough;

a downhole tool coupled to the or each reader; and

at least one tag moveable through at least a portion of the conduit and the reader wherein the or each tag is capable of containing data;

such that the reader is capable of reading data from the tag when the tag passes through the reader, thereby enabling remote actuation of the tool.

The inner diameter of the reader can be similar to the inner diameter of the conduit such that the reader does not cause a restriction in the conduit.

The conduit can comprise any downhole tubing string such as a drill string. One example of the downhole tool may be any valve such as a sliding sleeve. “Sliding sleeve” as used herein is intended to refer to any device that can be operated to selectively provide and prevent a flow path between the drill string and the annulus. Sliding sleeves incorporate one or more ports that can be opened or closed by a sliding component and can be used as a circulation sub.

Preferably, the reader can also transmit data and information to the tag regarding operating conditions of the tool or the external environment.

The at least one tag is preferably added to fluid circulating through the conduit. The tag may be recoverable after use in the conduit.

Two or more readers and respective coupled tools can be provided, the readers being individually identifiable or selectable, wherein the tags may be selectively coded with data, such that data from each tag is capable of being received by an individual reader. Therefore, the apparatus may preferably comprise several readers coupled to respective downhole tools and a plurality of tags, with certain tags encoded with data which may be read only by a particular reader with a unique identity for operation of a specific tool.

According to a second aspect of the present invention there is provided a method for operating a downhole tool comprising the steps of:

a) providing a conduit for the passage of fluid therethrough, the conduit comprising at least one reader also arranged for the passage of fluid therethrough, wherein the reader can read data;

b) coupling a downhole tool to the or each reader;

c) providing at least one tag wherein the or each tag is capable of containing data; and

d) moving the or each tag within the conduit and at least partially through the reader such that the reader is capable of reading data from the tag, when the tag passes through the reader, enabling remote operation of the tool.

The method typically comprises the step of running the downhole conduit into a borehole in between steps b) and c) or c) and d)

The method may further comprise the step of matching the inner diameter of the reader and conduit such that the inner diameter of the conduit is not restricted by the reader.

The tool coupled to a reader may be any valve such as a sliding sleeve. The conduit can be a drill string. The reader may also be arranged to transmit data.

Fluid may be circulated through the conduit and the at least one reader. Tags can be added to the circulating fluid. The method may comprise the additional step of recovering the tag after use.

Several readers may be arranged in series. The readers may have portions of conduit therebetween. The method may further comprise the step of providing each reader with a unique identity and selectively coding each tag such that a particular tag is arranged to communicate with a reader having a particular identity. In this way it is possible to target specific tools and send different operating instructions to each tool.

According to a third aspect of the present invention there is provided an antenna for use in a downhole tubular, the antenna comprising:

a generally cylindrical housing;

and a coiled conductor located within a portion of the housing and being separated from the portion of the housing by insulating material,

wherein the portion of the housing has a greater internal diameter than the external diameter of the coiled conductor.

One or more antennas can be provided for arrangement in a tubular.

The insulating material can be any suitable non-conducting material, such as air, glass fibre, rubber or ceramic. The antenna may further comprise a liner, wherein the coiled conductor is located or wrapped around the liner, preferably in a helical coaxial manner. Preferably, the housing and liner form a seal around the coiled conductor and insulating material. The housing can be made of steel. Preferably the liner should be non-magnetic and non-conductive to prevent eddy currents. Since the antenna is provided for use downhole, all components comprising the antenna are preferably capable of withstanding the high temperatures and pressures experienced downhole.

The antenna may operate in the frequency range 50 to 200 Khz. The optimum frequency band for the downhole work is 100 to 200 Khz. The most preferable frequency operating band is 125 to 134 Khz. The antenna should be of sufficient length to charge and read the RFID tag while passing through the antenna, allowing all data to be transferred. Preferably the length of the antenna is less than 10 m.

The antenna according to the third aspect of the invention can be used as the reader for the apparatus and method according to the first and second aspects of the invention.

Embodiments of the invention will be described with reference to and as shown in the accompanying drawings in which:

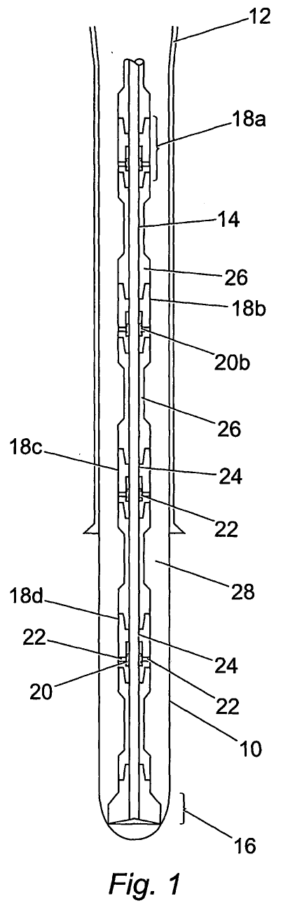

FIG. 1 is a sectional view of a borehole with drill string inserted therein, the drill string having attached apparatus according to the present invention;

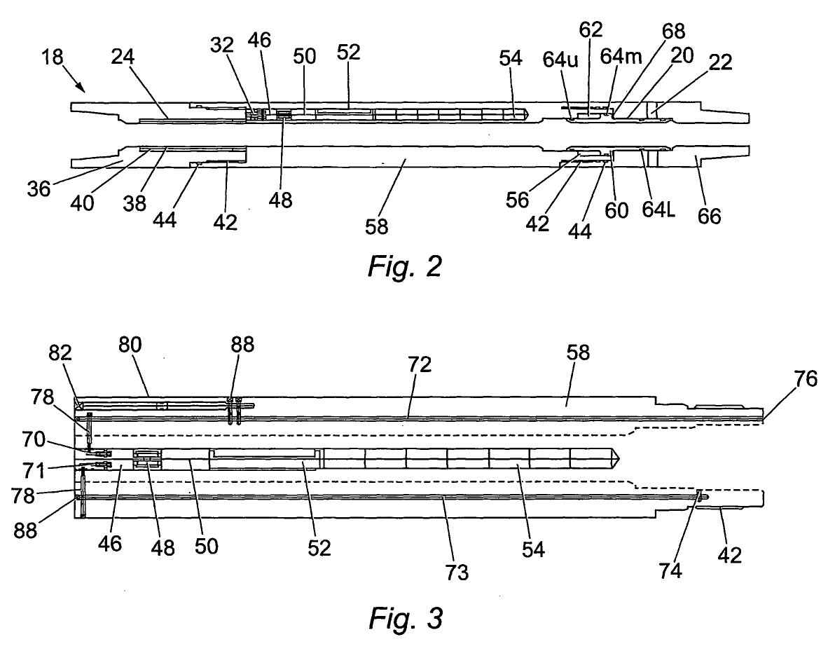

FIG. 2 shows a sectional view of circulation sub apparatus in accordance with the present invention;

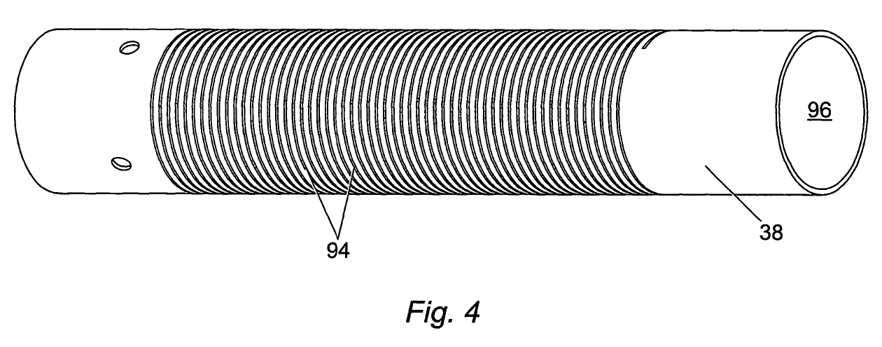

FIG. 3 is a top sectional view of the circulation sub of FIG. 2;

FIG. 4 is a perspective view of liner and coiled conductor required for construction of an antenna according to the present invention; and

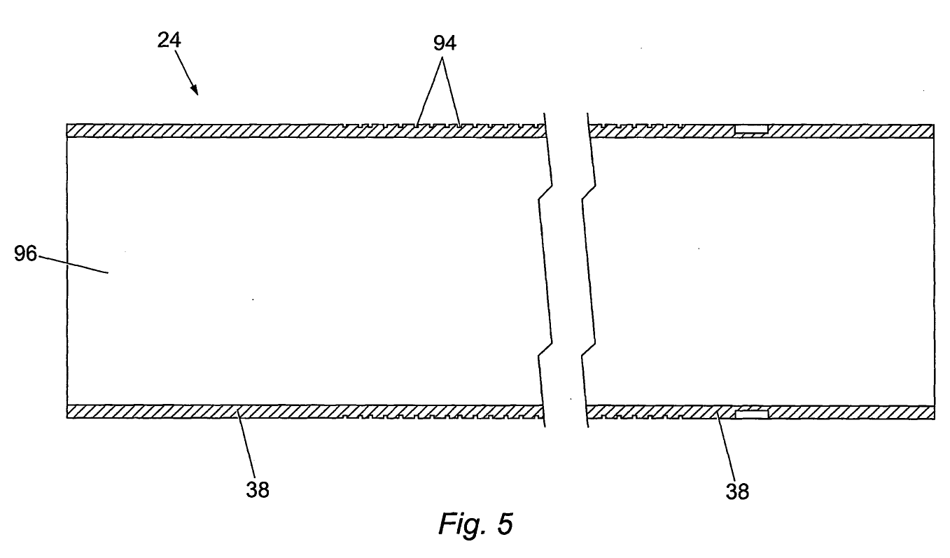

FIG. 5 is a sectional view through the antenna of FIG. 4.

FIG. 1 shows a borehole 10 lined in the upper region with a casing 12. A drill string 14 made up of lengths of drill pipe 26 is provided within the borehole 10. A drill bit 16 attached to the lower end of the drill string 14 is acting to drill the borehole 10 to thereby extend the borehole 10. The drill string 14 shown in FIG. 1 has four circulation subs 18a, 18b, 18c and 18d provided therein with drill pipe 26 therebetween. It should be noted that FIG. 1 is not to scale and that there may be many lengths of drill pipe 26 provided in between each of the circulating subs 18. The drill pipe 26 and circulation subs 18 are joined by conventional threaded torque pin and box connections. Each circulation sub 18 shown in FIG. 1 comprises a sliding sleeve valve 20, a port 22 and an antenna 24.

FIG. 2 shows a more detailed sectional view of the circulation sub 18. The circulation sub 18 has three main sections; a top sub 36, hydraulic housing 58 and bottom sub 66.

Towards the upper (in use) end of the circulation sub 18 there is provided the top sub 36 in which the antenna 24 is located where the antenna is typically in the region of 10 metres or less in length. As shown in the perspective view of FIG. 4 and sectional view of FIG. 5, the antenna 24 comprises an inner liner 38 located in an enlarged bore portion of the top sub 36, where the liner 38 is formed from a non-magnetic and non-conductive material such as fibreglass, moulded rubber or the like, having a bore 96 extending longitudinally therethrough. The inner bore 96 is preferably no narrower than the inner bore of the drill string 14. A coiled conductor (not shown) typically formed of, for example, a length of copper wire is concentrically wound around the liner 38 within grooves 94 in a helical coaxial manner. Referring again to FIG. 2, insulating material 40 formed from fibreglass, rubber or the like separates the coiled conductor 94 from the recessed bore of the top sub 36 in the radial direction. The antenna 24 is formed such that the insulating material 40 and coiled conductor are sealed from the outer environment and the inner throughbore by the inner liner 38 and the inner bore of the recess of the top sub 36.

The top sub 36 is joined to the hydraulic housing 58 via a pin and box threaded torque connection 42. O-ring seals 44 are also provided to create a fluid tight seal for the connection 42.

Within the hydraulic housing 58, a bulkhead 32 is positioned between outlet ports 70, 71. The outlet ports 70, 71 are ports for a hydraulic pump 46 which lies adjacent a gearbox 48. A motor 50 is connected to an electronics pack 52, both of which are powered by a battery pack 54.

The lower end of the hydraulic housing 58 is connected to a bottom sub 66 which has ports 22 extending through its side wall such that the throughbore of the bottom sub 66 can be in fluid communication with the annulus 28 (shown in FIG. 1) when the ports 22 are uncovered by the sliding sleeve 20. The bottom sub 66 is attached to the hydraulic housing 58 in the usual manner, by threaded connection 42 which are sealed with an O-ring 44. The sliding sleeve 20 is shown in a first position in FIG. 2 covering ports 22.

The inner diameter of the bottom sub 66 is stepped inwardly to create a shoulder 68 against which a piston 60 abuts in the first position when the fluid channel provided by the ports 22 between the throughbore of the bottom sub 66 and the annulus 28 is closed. The piston 60 can also occupy a second position in which the piston 60 abuts a shoulder 56 provided towards the lower end of hydraulic housing 58. FIG. 2 shows the piston 60 occupying the first position with the piston 60 in abutment with the shoulder 68 thereby creating a piston chamber 62. The piston chamber 62 is bordered by the sliding sleeve 20, piston 60, a portion of the hydraulic housing 58 and the shoulder 56. Piston seals 64U and 64M are used to create a fluid tight seal for the chamber 62.

FIG. 3 is a top view of a portion of the hydraulic housing 58 of the circulation sub 18. Connecting lines 78 connect the first pump outlet port 70 with a first hydraulic line 72 and the second pump outlet port 71 with a second hydraulic line 73. At one end, the hydraulic lines 72, 73, 78 are sealed by plugs 88. The other ends of the first and second hydraulic lines 72, 73 are provided with a first chamber opening 76 and a second chamber opening 74 respectively. The openings 74, 76 are arranged such that they are always located within the piston seals 64U, 64L.

The hydraulic line 72 is in fluid communication with a floating piston 80 having a screw plug 82 at one end thereof.

RFID tags (not shown) for use in conjunction with the apparatus described above can be those produced by Texas Instruments such as a 32 mm glass transponder with the model number RI-TRP-WRZB-20 and suitably modified for application downhole. The tags should be hermetically sealed and capable of withstanding high temperatures and pressures. Glass or ceramic tags are preferable and should be able to withstand 20 000 psi (138 MPa). Oil filled tags are also well suited to use downhole, as they have a good collapse rating.

In operation, a drill string 14 as shown in FIG. 1 is positioned downhole. The drill bit 16 suspended on the end of drill string 14 is rotated to extend the borehole 10. Nozzles (not shown) provided on the drill bit 16 expel fluid/mud at high velocity. The drilling fluid/mud is used for bit lubrication and cooling and is also circulated up the annulus created between the outside of the drill string 14 and the inner surface of the borehole to retrieve cuttings from the bottom of the borehole 10. If higher circulation rates are desired, ports 22 can be opened to create a path between the throughbore of the drill string 14 and the annulus 28 at the location of the respective ports 22. This can be achieved using the method and apparatus of the present invention, as described below.

Initially, the ports 22 are closed as they are covered by the sliding sleeve 20, shown in FIG. 1 and in greater detail in FIG. 2.

An RFID tag (not shown) is programmed at the surface by an operator to generate a unique signal in a frequency range which is preferably 125-134 Hz. Similarly, each of the electronics packs 52 coupled to the respective antenna 24, prior to being included in the drill string 14 at the surface, is separately programmed to respond to a specific signal within the preferred frequency range 125-134 Hertz. The RFID tag comprises a miniature electronic circuit having a transceiver chip arranged to receive and store information and a small antenna within the hermetically sealed casing surrounding the tag.

The pre-programmed RFID tag is then weighted, if required, and dropped or flushed into the well with the drilling fluid. After travelling through the inner bore of the drill string 14, the selectively coded RFID tag reaches the specific circulation sub 18 the operator wishes to actuate and passes through the inner liner 38 thereof. During passage of the RFID tag (not shown) through the top sub 36 in the upper end of the circulation sub 18, the antenna 24 housed therein is of sufficient length to charge and read data from the tag. The tag then transmits certain radio frequency signals, enabling it to communicate with the antenna 24. The data transmitted by the tag is received by the adjacent receiver antenna 24. This data is processed by electronics pack 52.

As an example the RFID tag in the present embodiment has been programmed at the surface by the operator to transmit information instructing that a particular sliding sleeve 20 (such as that of the second from bottom circulating sub 18c) is moved into the open position. The electronics pack 52 processes the data received by the antenna 24 as described above and recognises a flag in the data which corresponds to an actuation instruction data code stored in the electronics pack 52. The electronics pack 52 then instructs motor 50, powered by battery pack 54, to drive the hydraulic pump 46 of that circulating sub 18c. Hydraulic fluid is then pumped out of pump outlet 70, through connecting line 78 and hydraulic line 72 and out of chamber opening 76 to cause the space between piston seals 64M and 64L to fill with fluid thereby creating a new hydraulic fluid containing chamber (not shown). The volume of hydraulic fluid in first chamber 62 decreases as the piston 60 is moved towards the shoulder 56. Fluid exits the chamber 62 via chamber opening 74, along hydraulic line 73 and is returned to a hydraulic fluid reservoir (not shown). When this process is complete the piston 60 abuts the shoulder 56. This action therefore results in the sliding sleeve 20 moving towards the hydraulic housing 58 of the circulation sub 18 to uncover port 22 and opens a path from the interior of the drill string 14 to the annulus 26.

Therefore, in order to actuate a specific tool, for example sliding sleeve 20b, a tag programmed with a specific frequency is sent downhole. Sliding sleeve 20b is part of circulating sub 18b and is coupled to an antenna 24 responsive to the specific frequency of the tag. In this way tags can be used to selectively target certain tools by pre-programming readers to respond to certain frequencies and programming the tags with these frequencies. As a result several different tags may be provided to target different tools.

Several tags programmed with the same operating instructions can be added to the well, so that at least one of the tags will reach the desired antenna 24 enabling operating instructions to be transmitted. Once the data is transferred the other RFID tags encoded with similar data can be ignored by the antenna 24.

The tags may also be designed to carry data transmitted from antennas 24, enabling them to be re-coded during passage through the borehole 10. In particular, useful data such as temperature, pressure, flow rate and any other operating conditions of the tool etc can be transferred to the tag. The antenna 24 can emit a radio frequency signal in response to the RF signal it receives. This can re-code the tag with information sent from the antenna 24. The tag is typically recoverable from the cuttings lifted up the annulus from the borehole 10.

Modifications and improvements may be made to the embodiments hereinbefore described without departing from the scope of the invention. For example the sliding sleeve can be replaced by other types of movable tools that require remote actuation. In this case the tools may be operable directly by electrical power from the battery 54, rather than by hydraulic actuation.

1. A method for operating a downhole tool comprising the steps of:
providing a conduit for the passage of fluid therethrough, the conduit comprising at least one reader, also arranged for the passage of fluid therethrough, wherein the reader can read data;
coupling a downhole tool to the at least one reader;
providing at least one tag wherein the at least one tag is capable of containing data; and
moving the at least one tag within the conduit and at least partially through the reader, such that the reader is capable of reading data from the tag when the tag passes through the reader, enabling remote operation of the tool.

2. A method according to claim 1, comprising the step of running the conduit into a borehole.

3. A method according to claim 1, including the step of matching an inner diameter of the reader and an inner diameter of the conduit.

4. A method according to claim 1, comprising the step of coupling a valve to the reader.

5. A method according to claim 4, comprising the step of coupling a sliding sleeve valve to the reader.

6. A method according to claim 1, comprising the step of arranging the reader to transmit data.

7. A method according to claim 1, comprising the step of circulating fluid through the conduit and the at least one reader.

8. A method according to claim 7, comprising the step of adding at least one tag to the fluid circulating through the conduit and the at least one reader.

9. A method according to claim 8, comprising the step of recovering the at least one tag after use.

10. A method according to claim 1, including the step of arranging at least two readers in series along the conduit.

11. A method according to claim 10, comprising the step of arranging the at least two readers such that there is a portion of the conduit therebetween.

12. A method according to claim 11, comprising the step of providing each reader with a particular identity.

13. A method according to claim 12, comprising the step of selectively encoding the at least one tag such that a particular tag is arranged to communicate with a reader having a particular identity.

14. Apparatus for operating a downhole tool located in a conduit for the passage of fluid therethrough, the apparatus comprising: at least one reader associated with the conduit, wherein the at least one reader is arranged to read data and wherein the at least one reader is also arranged for the passage of fluid therethrough; a downhole tool coupled to the at least one reader; and at least one tag moveable through at least a portion of the conduit and the reader, wherein the at least one tag is capable of containing data, such that the reader is capable of reading data from the tag when the tag passes through the reader, thereby enabling remote actuation of the downhole tool.

15. Apparatus according to claim 14, wherein the reader is in fluid communication with the bore of the conduit.

16. Apparatus according to claim 14, wherein the reader is arranged on an inner surface of the conduit.

17. Apparatus according to claim 14, wherein the reader and the conduit each have an inner diameter and the inner diameter of the at least one reader is similar to the inner diameter of the conduit such that the at least one reader does not cause a restriction in the conduit.

18. Apparatus according to claim 14, wherein the conduit comprises a downhole tubing string.

19. Apparatus according to claim 14, wherein the downhole tool comprises valve.

20. Apparatus according to claim 19, wherein the valve is a sliding sleeve valve.

21. Apparatus according to claim 14, wherein the at least one reader is capable of transmitting data to the at least one tag.

22. Apparatus according to claim 14, wherein at least two readers and respective coupled downhole tools are provided and wherein each reader is individually identifiable.

23. Apparatus according to claim 22, wherein the at least one tag is selectively encoded with data such that data from the at least one tag is capable of being received by an individually identifiable reader.

24. An antenna for use in downhole tubular, the antenna comprising a generally cylindrical housing and a coiled conductor located within a portion of the housing and being separated from the portion of the housing by insulating material, wherein the portion of the housing has a greater internal diameter than an external diameter of the coiled conductor.

25. An antenna according to claim 24, comprising a liner, wherein the coiled conductor is located around the liner.

26. An antenna according to claim 25, wherein the conductor is helically coiled around the liner and co-axial therewith.

27. An antenna according to claim 25, wherein the housing and the liner form a seal around the coiled conductor and insulating material.

28. An antenna according to claim 25, wherein the liner is non-magnetic and non-conductive.

29. An antenna according to claim 24, wherein the antenna is operable in the frequency range from 50 to 200 kHz.

30. An antenna according to claim 24, wherein the antenna is operable in the frequency range between 125 and 134 kHz.

31. An antenna according to claim 24, wherein the antenna is of sufficient length to charge and read the at least one tag when the at least one tag passes therethrough.

32. An antenna according to claim 24, wherein the antenna has a length of less than 10 metres.
